(19) United States
(12) Patent Application Publication
(10) Pub. No.: US 2019/0283467 A1
(43) Pub. Date: Sep. 19, 2019

(54) IMAGE FORMING APPARATUS AND IMAGE FORMING APPARATUS BODY

(71) Applicants: Toshikane Nishii, Kanagawa (JP); Hiroshi ISHII, Kanagawa (JP); Kunihiko NISHIOKA, Kanagawa (JP); Akiyoshi TANAKA, Kanagawa (JP); Yasunari HARADA, Kanagawa (JP); Mitsutaka NAKAMURA, Kanagawa (JP)

(72) Inventors: Toshikane Nishii, Kanagawa (JP); Hiroshi ISHII, Kanagawa (JP); Kunihiko NISHIOKA, Kanagawa (JP); Akiyoshi TANAKA, Kanagawa (JP); Yasunari HARADA, Kanagawa (JP); Mitsutaka NAKAMURA, Kanagawa (JP)

(73) Assignee: Ricoh Company, Ltd., Tokyo (JP)

(21) Appl. No.: 16/243,423

(22) Filed: Jan. 9, 2019

(30) Foreign Application Priority Data
Mar. 17, 2018 (JP) 2018-050284

(51) Int. Cl. B41J 11/04; B41J 29/02; B41J 3/36

(52) U.S. Cl. CPC B41J 11/04; B41J 3/36; B41J 29/02

(57) ABSTRACT

An image forming apparatus includes a body, a recording device supported by the body and including a recording section configured to form an image on a recording medium, and two roller portions provided to the body. The two roller portions are configured to rotate on the recording medium while the body is moved in a scanning direction for image formation. The two roller portions are combined into a roller unit to rotate coaxially.

### CROSS-REFERENCE TO RELATED APPLICATION

This patent application is based on and claims priority pursuant to 35 U.S.C. § 119(a) to Japanese Patent Application No. 2018-050284, filed on Mar. 17, 2018, in the Japan Patent Office, the entire disclosure of which is hereby incorporated by reference herein.

### BACKGROUND

### Technical Field

The present disclosure generally relates to an image forming apparatus and an image forming apparatus body.

### Description of the Related Art

There are mobile image forming apparatuses including a body provided with a roller to contact a recording medium and rotate thereon. Such a mobile image forming apparatus forms an image on the recording medium with the roller rotating on the recording medium, as the mobile image forming apparatus is moved in a scanning direction.

### SUMMARY

According to an embodiment of this disclosure, an image forming apparatus includes a body, a recording device supported by the body and including a recording section configured to form an image on a recording medium, and two roller portions provided to the body. The two roller portions are configured to rotate on the recording medium while the body is moved in a scanning direction for image formation. The two roller portions are combined into a roller unit to rotate coaxially.

According to another embodiment, an image forming apparatus includes a body including a recording side, a recording device supported by the body, and a roller portion provided to the body. The recording device includes a recording section configured to form an image on a recording medium and exposed on the recording side. The roller portion is configured to rotate on the recording medium while the body is moved in a scanning direction for image formation. The roller portion is disposed at a position deviated from the recording section in an orthogonal direction along the recording side and orthogonal to the scanning direction.

Another embodiment provides a body of an image forming apparatus to form an image on a recording medium. The body is configured to house a recording device to form an image on a recording medium. The body includes two roller portions configured to rotate on the recording medium while the body is moved in a scanning direction for image formation, and the two roller portions are combined in a roller unit to rotate coaxially.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a perspective view illustrating an exterior of a handheld mobile inkjet printer (hereinafter simply “handheld printer”) according to an embodiment of the present disclosure, as viewed obliquely from above;

FIG. 2 is a perspective view illustrating the handheld printer being moved, together with a recording medium and a portion of an image immediately after formed;

FIG. 3 is a perspective view of the handheld printer in a state in which an upper unit is opened with respect to a lower unit;

FIG. 4 is a bottom view of the handheld printer as viewed from a recording side;

FIG. 5 is a block diagram illustrating a part of an electric circuit of the handheld printer, according to an embodiment;

FIG. 6 is a perspective view illustrating relative positions between a print button of the handheld printer and a recording section;

FIG. 7 is a plan view illustrating the handheld printer forming an image on a recording medium, together with the recording medium and an image portion immediately after formed;

FIG. 8 is a perspective view illustrating the handheld printer with a print button emitting light;

FIG. 9 is a bottom view illustrating the handheld printer with left and right roller units removed therefrom;

FIG. 10 is a partial cross-sectional view of the lower unit of the handheld printer, with the left roller unit attached thereto;

FIG. 11 is a schematic view illustrating the position of each roller portion of the left and right roller units illustrated in FIG. 10, in an example in which the direction in which a pressing flat spring presses the left roller unit is opposite the direction in which the pressing flat spring presses the right roller unit;

FIG. 12 is a schematic view illustrating positions of the roller portions illustrated in FIG. 11, in the handheld printer;

FIG. 13 is a side view illustrating a hand of a user moving the handheld printer;

FIG. 14 is a perspective view illustrating the handheld printer being moved along a curved track in a roller contactless state;

FIG. 15 is a perspective view illustrating a lower unit of a handheld printer and a spacer as viewed from the recording side, according to Variation 1;

FIG. 16 is a perspective view illustrating the lower unit in a state in which the spacer is mounted, according to Variation 1;

FIG. 17 is a partial rear view illustrating a lower unit of a handheld printer according to Variation 2;

FIG. 18 is a partial rear view illustrating a lower unit of a handheld printer according to Variation 3;

FIG. 19 is a bottom view illustrating a handheld printer according to Variation 4;

FIG. 20 is a bottom view illustrating a handheld printer according to Variation 5;

FIG. 21 is a bottom view illustrating a handheld printer according to Variation 6; and

FIG. 22 is a vertical cross-sectional view illustrating a roller unit in which roller portions and a shaft are molded as a single piece of the same material, according to an embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

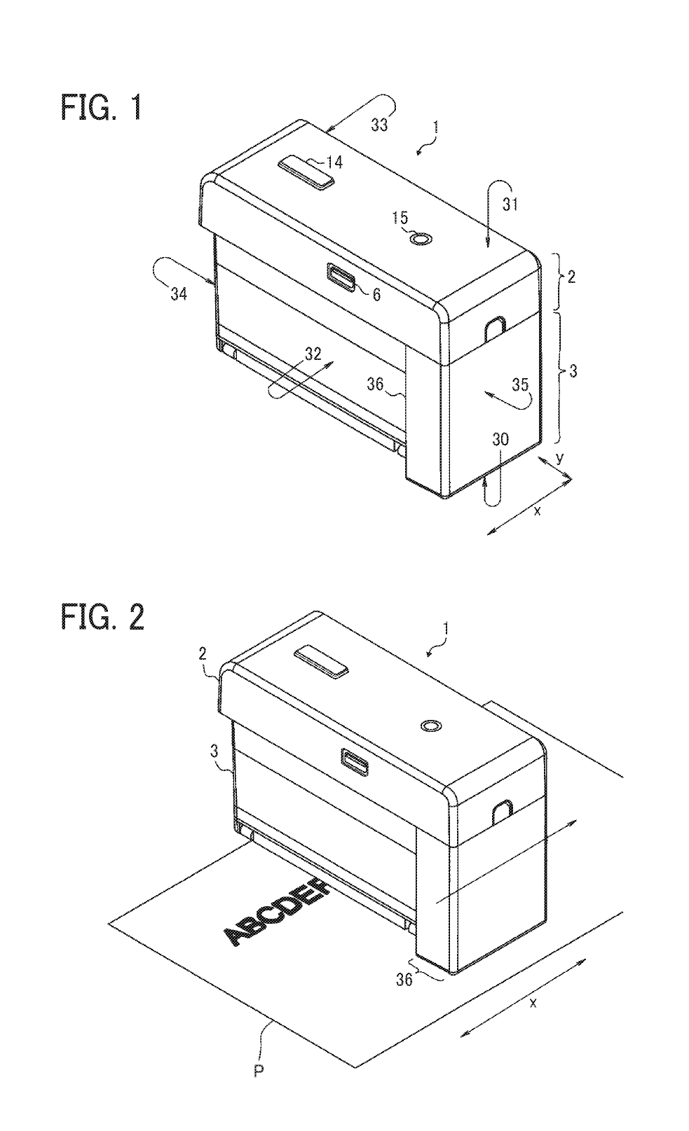

Referring now to the drawings, wherein like reference numerals designate identical or corresponding parts throughout the several views thereof, and particularly to FIG. 1, as an example of an image forming apparatus according to an embodiment of this disclosure, a handheld mobile inkjet printer (hereinafter simply referred to as “handheld printer”) is described. As used herein, the singular forms “a”, “an”, and “the” are intended to include the plural forms as well, unless the context clearly indicates otherwise.

A basic configuration of the handheld printer according to the present embodiment is described with reference to FIG. 1.

FIG. 1 is a perspective view illustrating an exterior of a handheld printer 1 according to the present embodiment, as viewed obliquely from above. The handheld printer 1 illustrated in FIG. 1 includes an upper unit 2 and a lower unit 3. The handheld printer 1 illustrated in FIG. 1 as a whole is shaped like a rectangular parallelepiped. The handheld printer 1 has such a width in a scanning direction (that is, a printing direction indicated by arrow x in FIG. 1) that a user can grasp the handheld printer 1 with a palm.

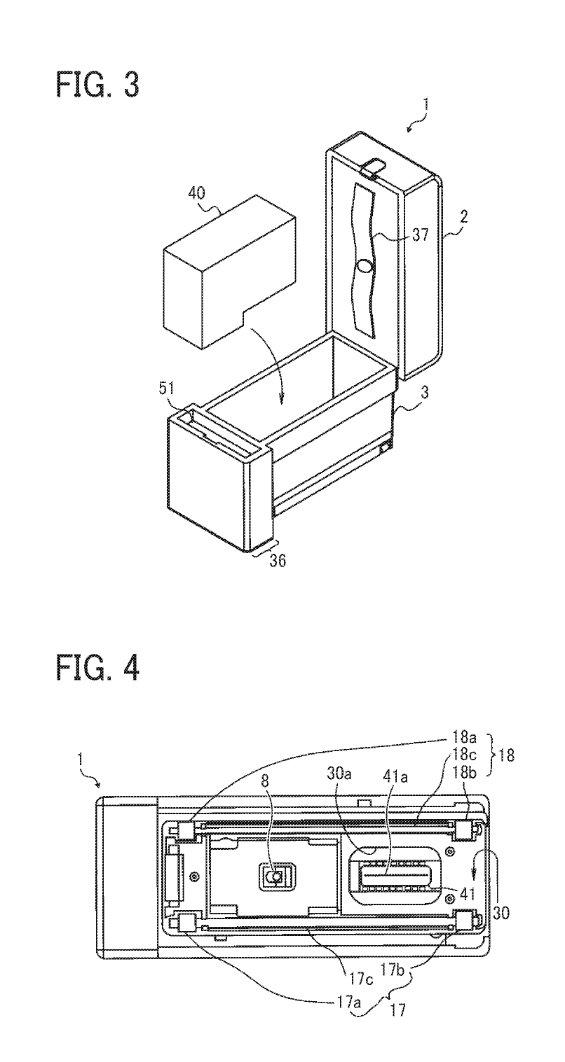

The housing of the handheld printer 1 includes a recording side 30, an upper side 31 opposite the recording side 30, a left side 32 extending in a direction indicated by arrow y, orthogonal to the scanning direction (hereinafter “orthogonal direction y”), and the like. On the recording side 30, a recording section 41 (see FIG. 4) of an inkjet head 40 (see FIG. 3), serving as a recording device to be described later, faces a recording medium such as a sheet. The recording section 41 includes a plurality of ink discharge nozzles. The housing further includes, for example, a right side 33 extending in the orthogonal direction y orthogonal to the scanning direction (indicated by arrow x), a rear side 34 extending in the scanning direction, and a front side 35 extending in the scanning direction. When the orthogonal direction y is mentioned with respect to the recording medium, the orthogonal direction y is orthogonal to the scanning direction on the surface of the recording medium. When the orthogonal direction y is mentioned with respect to the handheld printer 1, the orthogonal direction y is orthogonal to the scanning direction on the recording side 30.

FIG. 1 illustrates the handheld printer 1 being in such a posture that the recording side 30 (i.e., a bottom face in FIG. 1) is faced vertically down and the upper side 31, which is opposite the recording side 30, is faced vertical up. A print button 14 and a power button 15 are disposed within an outer edge (within a frame) of the upper side 31. The left side 32 of the upper unit 2 includes a universal serial bus (USB) connection port 6.

The USB connection port 6 is a port for connecting a USB cable. The handheld printer 1 is provided with a rechargeable battery 51 (illustrated in FIG. 3) mounted therein. The rechargeable battery 51 can be charged when electric power is supplied thereto from an external power supply via the USB cable connected to the USB connection port 6.

An end of the lower unit 3 on the side of the front side 35 is a grip portion 36 greater in width than a rest of the lower unit 3 other than the grip portion 36. When the user moves the handheld printer 1 on a surface of the recording medium in the scanning direction (indicated by arrow x) for image formation, the user holds the grip portion 36 to move the handheld printer 1. The grip portion 36 is made wider in the scanning direction (indicated by arrow x) because the grip portion 36 serves as a battery storage described later in addition to the convenience of the user in holding the handheld printer 1 with a hand.

The user can hold down the power button 15 for a while to switch on and off the power of the handheld printer 1. With the power turned on, a control board mounted in the upper unit 2 of the handheld printer 1 can acquire image information by Bluetooth (registered trademark) communication with, e.g., a smartphone. After the user places the handheld printer 1 on the surface of a recording medium P (see FIG. 2) with the recording side 30 facing the recording medium P, the user presses the print button 14 once and moves the handheld printer 1 in the scanning direction as illustrated in FIG. 2, thus forming an image on the recording medium P. Thus, the print button 14 serves as an instruction input portion to be operated by the user for input of an operation instruction. The handheld printer 1 can form an image on the surface of the recording medium P both when the handheld printer 1 is moved forward in the scanning direction (indicated by arrow x) by the user and when the handheld printer 1 is moved backward in the scanning direction.

The recording medium is not limited to paper, such as paper sheets, but includes, for example, overhead projector (OHP) sheets, cloth, cardboards, packaging containers, glass, and substrates.

FIG. 3 is a perspective view of the handheld printer 1 in a state in which the upper unit 2 is opened with respect to the lower unit 3. As illustrated in FIG. 3, the upper unit 2 is held by the lower unit 3 to open and close with respect to the lower unit 3. The battery 51 to supply power to each device of the handheld printer 1 is housed in an inner space of the grip portion 36 of the lower unit 3.

An inkjet head 40 combined with an ink tank (an ink cartridge) is removably mounted in a portion of the lower unit 3 different from the grip portion 36. As illustrated in FIG. 3, the inkjet head 40, that is, the ink cartridge, includes the recording section 41 (see FIG. 4) and the ink tank combined into a single unit and is removable from the lower unit 3 of the handheld printer 1. At this time, the recording section 41 to discharge ink droplets is faced down in the vertical direction. The inkjet head 40 discharges ink droplets from the recording section 41 to record an image on a recording medium.

On the inner face of the upper unit 2, a head-pressing flat spring 37 to press and hold the inkjet head 40 mounted in the lower unit 3 is attached.

In the handheld printer 1, since the battery 51 is disposed on a side of the inkjet head 40 in the lower unit 3, the height of the handheld printer 1 is smaller compared with a configuration in which the battery 51 is disposed above the inkjet head 40. Such placement lowers the position of the center of gravity (gravity center position) of the handheld printer 1, thus preventing the handheld printer 1 from falling over while being move.

The handheld printer 1 is designed to be compact in the scanning direction such that the size (apparatus width) of the handheld printer 1 is slightly wider than the inkjet head 40 in the scanning direction. As the apparatus width becomes larger, the range in which the handheld printer 1 can be moved in the scanning direction on the surface of the recording medium P becomes smaller, and the recordable range also becomes narrower. Reducing the apparatus width as much as possible can maximize the recordable range on the surface of the recording medium P.

FIG. 4 is a bottom view of the handheld printer 1 as viewed from the recording side 30. In FIG. 4, the recording side 30 of the handheld printer 1 includes an opening 30a to expose the recording section 41 of the inkjet head 40 mounted in the lower unit 3 (FIG. 3) to the outside. The recording section 41 includes a plurality of discharge nozzles 41a (e.g., orifices) and is capable of discharging ink droplets separately from the respective discharge nozzles 41a as piezoelectric elements are driven.

The recording section 41 is a region inside (on the side of the discharge nozzles 41a) a plurality of inner leads surrounding the discharge nozzles 41a along the surface of the substrate of the inkjet head 40. In the handheld printer 1, the area of the recording section 41 on the substrate is painted white to be clearly distinguished from the surrounding black area. In other words, the white area is a mark representing the recording section 41. The shape of the mark is rectangular as illustrated in the drawing.

As a driver for ink discharge, the inkjet head 40 employs, for example, piezoelectric actuators (laminated piezoelectric elements or thin-film piezoelectric elements) or electrostatic actuators including electrothermal transducer elements, such as heat elements, made of diaphragms and opposed electrodes.

The “liquid” discharged from the discharge nozzles 41a of the recording section 41 is not particularly limited as long as the liquid has a viscosity and a surface tension that can be discharged from the discharge nozzles 41a. However, it is preferable that the viscosity is 30 mPa·s or less under ordinary temperature and pressure or by heating or cooling. Specifically, the term “liquid” represents, for example, a solution, a suspension, or an emulsion including a solvent, such as water or organic solvent, a colorant, such as a dye or a pigment, a polymerizable compound, a resin, a functional material, such as a surfactant, a biocompatible material, such as deoxyribonucleic acid (DNA), amino acid, protein, or calcium, or an edible material, such as a natural colorant. Such a solution, a suspension, or an emulsion can be used for, e.g., inkjet ink, a surface treatment solution, liquid for forming components of electronic elements or light-emitting elements, liquid for forming resist patterns of electronic circuits, or a material solution for three-dimensional fabrication.

Disposed inside the outer edge of the recording side 30 are a position sensor 8 (a detector) to detect the position of the handheld printer 1 on the recording medium, a first left roller portion 37a, a second left roller portion 37b, a first right roller portion 38a, and a second right roller portion 38b. These roller portions are rotatable.

When the user moves the handheld printer 1 in the scanning direction, the four roller portions contacting the surface of the recording medium P rotate like tires. Owing to such roller portions, the user can advance the handheld printer 1 straight in the scanning direction. At this time, only the four roller portions of the handheld printer 1 are in contact with the surface of the recording medium P, and the recording side 30 is not in contact with the surface of the recording medium P. Therefore, a constant distance can be maintained between the recording section 41 of the inkjet head 40 and the surface of the recording medium P, thus forming a desired high-quality image.

The position sensor 8 is a sensor to detect the distance to the surface of the recording medium P, the surface state (for example, asperities) of the recording medium P, and the distance by which the handheld printer 1 has traveled. The position sensor 8 is similar to a sensor used for, for example, an optical mouse (a pointing device) of a personal computer. The position sensor 8 irradiates, with light, a place (recording medium) where the position sensor 8 is placed and reads the state of the place as a “pattern”. The position sensor 8 sequentially detects how the “pattern” moves relative to the movement of the position sensor 8, to calculate the amount of movement.

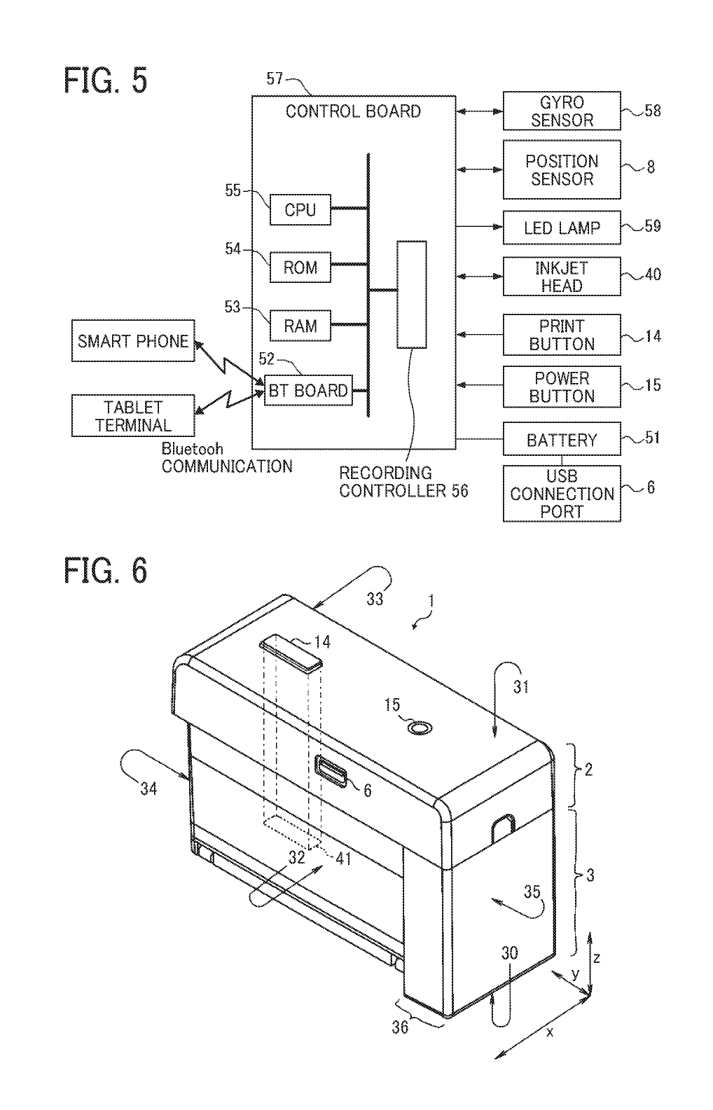

FIG. 5 is a block diagram illustrating a portion of an electric circuit of the handheld printer 1.

A control board 57 includes a central processing unit (CPU) 55 that performs various arithmetic processing and program execution, a Bluetooth (registered trademark) board (Bt board) 52, a random access memory (RAM) 53 that temporarily stores data, a read-only memory (ROM) 54, and a recording controller 56. The control board 57 is secured at a position on the back side of the USB connection port 6 (illustrated in FIG. 1) in a hollow space of the upper unit 2 (illustrated in FIG. 1).

The Bt board 52 performs data communication by Bluetooth communication with an external device, such as a smartphone or a tablet terminal. The ROM 54 stores, for example, firmware for hardware control of the handheld printer 1 and drive waveform data of the inkjet head 40. The recording controller 56 executes data processing for driving the inkjet head 40 and generates drive waveforms.

To the control board 57, a gyro sensor 58, the position sensor 8, a light emitting diode (LED) lamp 59, the inkjet head 40, the print button 14, the power button 15, and the battery 51 are electrically connected.

The gyro sensor 58 detects the tilt and rotation angle of the handheld printer 1 and transmits the result of detection to the control board 57. The LED lamp 59 is disposed inside an exterior cover made of a light transmissive material of the print button 14 and makes the print button 14 luminous.

When the power button 15 is pressed to turn on the power of the handheld printer 1, power is supplied to each module. The CPU 55 initiates startup according to the program stored in the ROM 54 and develops the program and each data in the RAM 53. When data of image to be formed is received from an external device by Bluetooth communication, the recording controller 56 generates a drive waveform corresponding to the image data. The discharge of ink from the inkjet head 40 is controlled so as to form an image corresponding to the position on the surface of the recording medium P detected by the position sensor 8.

FIG. 6 is a perspective view for explaining relative positions of the print button 14 of the handheld printer 1 and the recording section 41. In FIG. 6, the print button 14 is disposed within the plane of the upper side 31 being a face opposite the recording side 30. Further, the recording section 41 is disposed within the plane of the recording side 30. The print button 14 is disposed so that an image of the print button 14 projected in the opposing direction of the recording side 30 and the upper side 31 overlaps the recording section 41. That is, the print button 14 is disposed directly above the recording section 41.

The planar shape and the planar size of the print button 14 are the same as the planar shape and planar size of the mark (indicated by broken line in the drawing) representing the recording section 41. The expression “the planar shape and the planar size are the same as” includes not only the case where the shapes and the sizes coincide exactly but also a case where some dimensional differences exist.

The print button 14 is used as a guide for indicating the position of recording by the recording section 41 to the user viewing the upper side 31 in addition to the button with which the user inputs a print instruction. Looking the upper side 31 of the handheld printer 1, the user can know the recording position in the scanning direction (indicated by arrow x) on the surface of the recording medium P and the recording position in the orthogonal direction y orthogonal to the scanning direction.

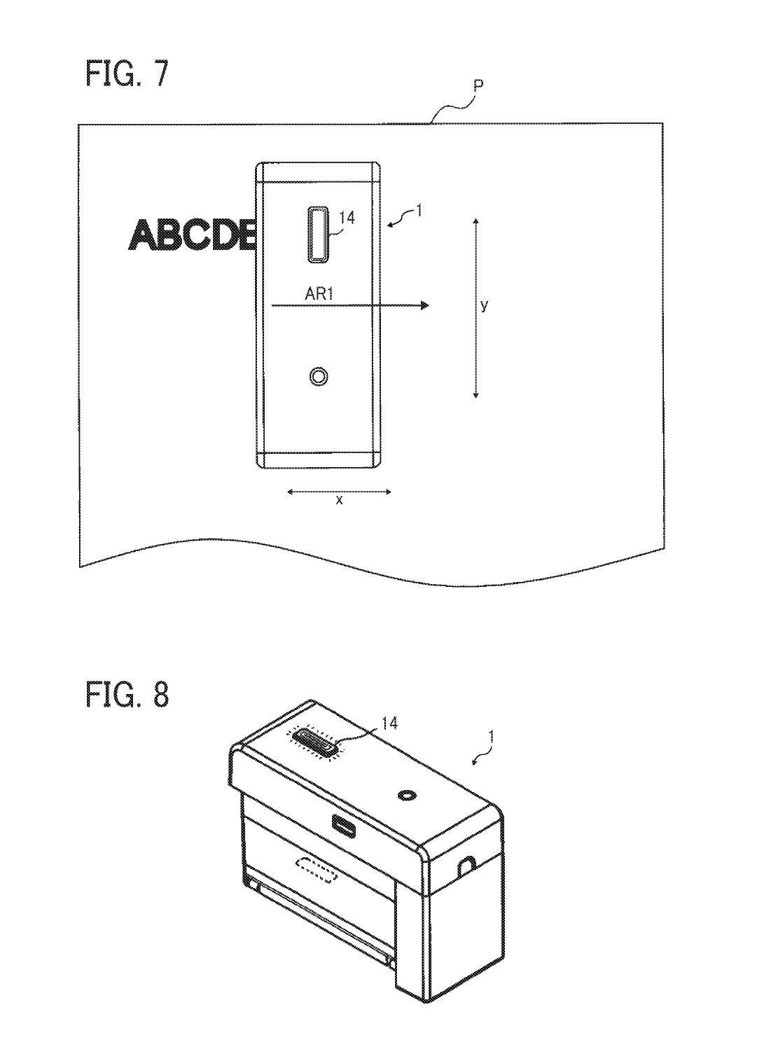

FIG. 7 is a plan view illustrating the handheld printer 1 forming an image on the recording medium P, together with the recording medium P and the image portion immediately after formed. The user moves the handheld printer 1 placed on the surface of the recording medium P in the direction indicated by arrow AR1 in FIG. 7 to cause the handheld printer 1 to execute the image formation. At this time, the line of sight looking at the print button 14 as the guide is at an angle looking straight down the handheld printer 1 as illustrated in FIG. 7. Then, the left-hand side and the right-hand side of the recording medium P can be visually recognized easily. Accordingly, the position of the handheld printer 1 can be easily kept to such a position that the longitudinal direction of the handheld printer 1 (the orthogonal direction y in the figure) parallels the left side or the right side of the recording medium P. Therefore, the image can be easily formed straight along the lateral direction or the longitudinal direction of the recording medium P.

When the print button 14 used for inputting the print instruction serves as the guide, the following advantage is attained. When the user presses the print button 14 to start printing, the user recognizes, visually and with tactile sensation, the position of recording by the recording section 41. Thus, the user can easily grasp the recording position.

In response to acquisition of image data via Bluetooth communication from an external device, the control board 57 illustrated in FIG. 5 causes the LED lamp 59 to blink so that the print button 14, which transmits light, becomes luminous and blinks. Seeing such blinking, the user knows that the acquisition of the image data of handheld printer 1 has ended. Then, the user places the handheld printer 1 on the recording medium P and presses the print button 14.

Meanwhile, as the control board 57 starts blinking of the LED lamp 59, the control board 57 waits for pressing of the print button 14. When the print button 14 is pressed, the control board 57 causes the LED lamp 59 to keep emitting light so that the print button 14 continuously emit light as illustrated in FIG. 8. Seeing the continuous light emission, the user starts moving the handheld printer 1 in the scanning direction. At this time, the print button 14 continuously emitting light helps the user to grasp the recording position.

Finishing moving of the handheld printer 1, the user picks up the handheld printer 1 from the recording medium P and places the handheld printer 1 on a table or the like. When the handheld printer 1 is picked up from the recording medium P, the position sensor 8 does not detect the position. At the timing when the position sensor 8 no longer detects the position, the control board 57 turns off the LED lamp 59 and stops lighting of the print button 14. Seeing the stop of lighting, the user can know that the operation of the handheld printer 1 for printing has ended.

It is not necessary to keep pushing the print button 14 while the user moves the handheld printer 1. Once the print button 14 is pushed and released before the moving of the handheld printer 1, the image forming operation based on the detection result by the position sensor 8 is continued until the end of the image formation or end of the position detection by the position sensor 8.

A description is given of an inconvenience in printers that includes two roller portions arranged in a direction of width of the printer orthogonal to the scanning direction of the printer. During scanning by the printer, the two roller portions rotate, like wheels, while being in contact with the recording medium. If the two roller portions are allowed to rotate individually, a linear speed difference may occur between the two roller portions, or the two roller portions may rotate in the opposite directions. In such a configuration, application of even a slight force in a direction deviated from the scanning direction from the user to the printer during the moving of the printer causes a linear speed difference or a reverse rotation between the two roller portions. It is possible that the linear speed difference or reverse rotation cause one of the roller portions to slip on the recording medium and prompts a direction change toward that direction, thereby easily changing the direction of the printer. Therefore, it is difficult to move the printer straight in the scanning direction.

Descriptions are given below of a feature of the handheld printer 1 according to the present embodiment.

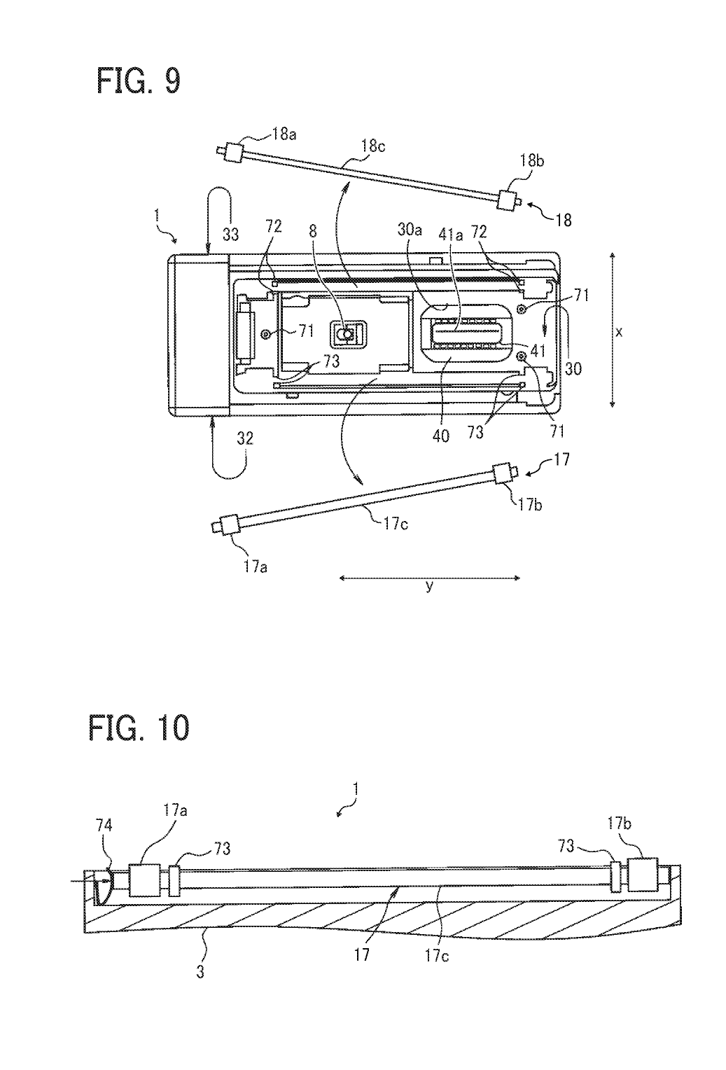

FIG. 9 is a bottom view illustrating the handheld printer 1 with the left roller unit 17 and the right roller unit 18 separated therefrom. The handheld printer 1 includes the left roller unit 17 and the right roller unit 18. The left roller unit 17 is attached to an end on the left side 32 in the scanning direction (indicated by arrow x) of the handheld printer 1. The right roller unit 18 is attached to an end on the right side 33 in the scanning direction of the handheld printer 1. The left and right roller units 17 and 18 extend in the orthogonal direction y. That is, the axis of the first and second roller portions 17a and 17b are orthogonal to the scanning direction.

The left roller unit 17 includes a metal shaft 17c, the first roller portion 17a fixed (or secured) to one end side in the longitudinal direction of the shaft 17c, and the second roller portion 17b fixed (or secured) to the other end side of the shaft 17c. Each of the first roller portion 17a and the second roller portion 17b is made of a material, such as rubber, having a relatively large frictional resistance. The The right roller unit 18 includes a metal shaft 18c, the first roller portion 18a fixed (or secured) to one end side in the longitudinal direction of the shaft 18c, and the second roller portion 18b fixed (or secured) to the other end side of the shaft 18c. Each of the first roller portion 18a and the second roller portion 18b is made of a material, such as rubber, having a relatively large frictional resistance.

As end portions in the longitudinal direction of the shaft 17c are fitted in sliding bearings 73 fixed to the handheld printer 1, the left roller unit 17 is rotatably held by the sliding bearings 73. The sliding bearing 73 includes a cutout portion in the circumferential direction, and the shaft 17c is inserted into the bearing through the cutout portion. At this time, the sliding bearing 73 is temporarily deformed by the force pushing in the shaft 17c so that the width of the cutout portion, which is smaller than the diameter of the shaft 17c in a normal state, is expanded to be approximately equal to the diameter of the shaft 17c. When the shaft 17c is fully pushed in the sliding bearing 73, the deformation of the sliding bearing 73 is canceled, and the width of the cutout portion becomes smaller than the diameter of the shaft 17c. As a result, the left roller unit 17 is rotatably held by the sliding bearing 73.

Similar to the left roller unit 17 described above, the right roller unit 18 is rotatably held by sliding bearings 72 fixed to the handheld printer 1.

The left roller unit 17 and the right roller unit 18 are for enhancing the straight traveling performance of the handheld printer 1 in the scanning direction (indicated by arrow x). While the first roller portion 17a and the second roller portion 17b secured to the shaft 17c rotate together as one unit, the first roller portion 18a and the second roller portion 18b secured to the shaft 18c rotate together as one unit, thus improving the straight traveling performance.

More specifically, even when the user applies force in a direction deviated from the scanning direction during the moving of the handheld printer 1, the first roller portion 17a and the second roller portion 17b of the left roller unit 17 rotate as one unit on the same axis. This configuration prevents a linear speed difference or reverse rotation that causes one of the first and second roller portions 17a and 17b to slip on the recording medium P and prompts a direction change toward that direction, and the two roller portions (17a and 17b) are caused to rotate at the same linear speed to advance in the scanning direction. Therefore, the user can easily move the handheld printer 1 straight in the scanning direction.

Although the description above concerns how the left roller unit 17 enhances the straight traveling performance of the handheld printer 1, the right roller unit 18 enhances the straight traveling performance of the handheld printer 1 similarly.

In the handheld printer 1, the two roller portions 17a and 17b of the left roller unit 17 and the two roller portions 18a and 18b of the right roller unit 18 are disposed at positions deviating from the recording section 41 in the orthogonal direction y to the scanning direction. Specifically, each of the four roller portions 17a, 17b, 18a, and 18b are disposed as follows. A projected image of the recording section 41 projected in the opposing direction (z-axial direction in FIG. 6) between the recording section 41 (placed on the recording medium P) and the recording medium P does not overlap with a projected image of the roller portion projected in the scanning direction. In such an arrangement, when the handheld printer 1, which can scan the recording medium P reciprocally, is moved forward, the first and second roller portions 17a and 17b of the left roller unit 17 are inhibited from contacting an image portion immediately after formed. In addition, when the handheld printer 1 is moved backward, the first and second roller portions 18a and 18b of the right roller unit 18 are inhibited from contacting an image portion immediately after formed. Therefore, the image can be protected from being disturbed by the roller portions 17a, 17b, 18a, and 18b contacting the image portion immediately after formed.

As the distance between the two roller portions (17a and 17b, and 18a and 18b) in the rotation axis direction increases, the roller units 17 and 18 can enhance the straight traveling performance of the handheld printer 1. Therefore, in the handheld printer 1, the first roller portions 17a and 18a are disposed at a position deviated from the recording section 41 toward the one end side (to the front side 35) in the orthogonal direction y to the scanning direction. In addition, the second roller portions 17b and 18b are disposed at a position deviated from the recording section 41 to the other end side (to the rear side 34). In such a structure, compared with a structure in which two roller portions are disposed together at one end side or the other end side, the distance in the direction between the two roller portions in the direction orthogonal to the scanning direction is greater, thereby improving the straight traveling performance of the handheld printer 1.

As described above, the shafts 17c and 18c of the roller units 17 and 18 are made of metal. Compared with a structure using a nonmetallic shaft, use of the metal shaft is advantageous in suppressing bend of the shaft during moving of the handheld printer 1, thereby inhibiting the image from being disturbed by unstable traveling of the handheld printer 1 due to the flexure of the shaft. Further, the handheld printer 1 can be compact when a shaft having a small diameter is used.

The handheld printer 1 includes, not only the left roller unit 17, but also the right roller unit 18 disposed on the side of the left roller unit 17 in the scanning direction. In such a configuration, the two roller units 17 and 18 resist the forces deviating from the scanning direction at different positions in the scanning direction. Accordingly, the straight traveling performance of the handheld printer 1 can be further enhanced.

FIG. 10 is a partial cross-sectional view of the lower unit 3 of the handheld printer 1, with the left roller unit 17 attached thereto. In the figure, the lower unit 3 is illustrated with the recording side 30 (illustrated in FIG. 9) facing up. A pressing flat spring 74 is attached to a wall of the lower unit 3. The pressing flat spring 74 presses one longitudinal end of the shaft 17c of the left roller unit 17 toward the other end side in the axial direction so that the other longitudinal end of the shaft 17c is pressed against an inner wall of the casing of the lower unit 3.

In this manner, the shaft 17c of the left roller unit 17 is pressed in the axial direction by the pressing flat spring 74 to suppress the backlash of the first roller portion 17a and the second roller portion 17b in the axial direction (eliminate space allowing backlash). Giving attention to the left roller unit 17, the left roller unit 17 rattles in the axial direction relative to the casing of the handheld printer 1, but the casing rattles relative to the left roller unit 17 during the moving of the handheld printer 1. The recording section 41 is secured at position inside the casing of the lower unit 3. Accordingly, the image is disturbed if the casing of the lower unit 3 rattles during the moving of the handheld printer 1. Pressing the shaft 17c in the axial direction with the pressing flat spring 74 can inhibit rattling of the casing of the lower unit 3 during the moving of the handheld printer 1 and image disturbance due to the rattling.

Although the description above concerns pressing the shaft 17c of the left roller unit 17 in the axial direction with the pressing flat spring 74, the shaft 18c of the right roller unit 18 is similarly pressed in the axial direction by a pressing flat spring. Examples of the pressing member is not limited to flat springs but include other types of springs, such as coil springs, and elastic members such as a rubber body.

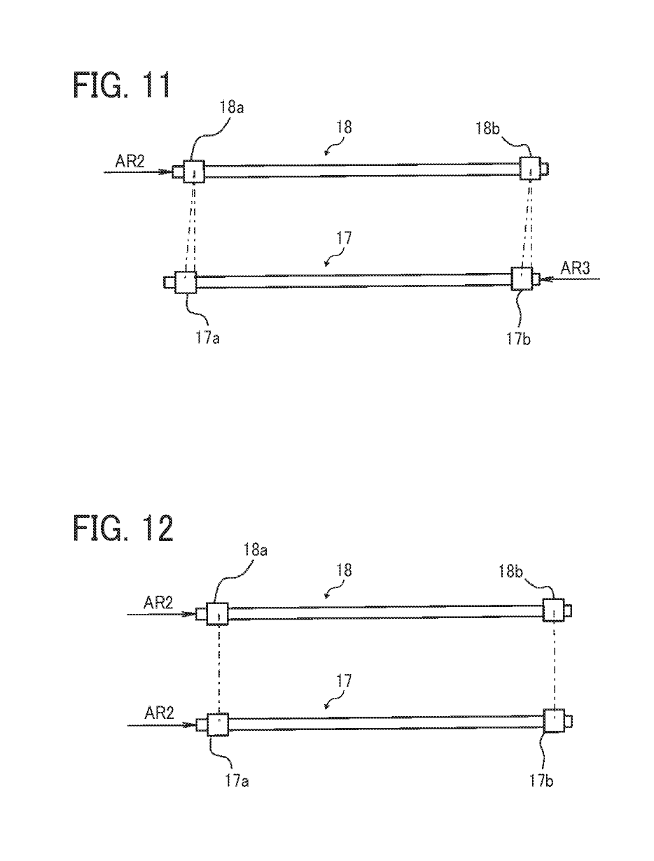

FIG. 11 is a schematic view illustrating the position of each roller portion in an example in which the direction in which the pressing flat spring 74 presses the left roller unit 17 is opposite the direction in which the pressing flat spring presses the right roller unit 18.

In FIG. 11, arrows AR2 and AR3 indicate pressing directions by the pressing flat springs 74 illustrated in FIG. 10. As illustrated in the drawing, when the pressing directions of the two pressing flat springs 74 are opposite to each other, the direction in which the left roller unit 17 is pressed against the casing to eliminate backlash is opposite the direction in which the right roller unit 18 is pressed against the casing to eliminate backlash. As a result, the first roller portion 17a of the left roller unit 17 undesirably deviates in the axial direction from the first roller portion 18a of the right roller unit 18. Likewise, the second roller portion 17b of the left roller unit 17 undesirably deviates in the axial direction from the second roller portion 18b of the right roller unit 18. As a result, the straight traveling performance of the handheld printer 1 is lowered.

Therefore, in the handheld printer 1, the pressing flat spring 74 and the pressing flat spring for the right roller unit 18 are disposed such that the direction in which the pressing flat spring 74 presses the shaft 17c of the left roller unit 17 is the same as the direction in which the pressing flat spring presses the shaft 18c of the right roller unit 18.

With such a configuration, as illustrated in FIG. 12, the roller portions 17a and 17b of the left roller unit 17 and the roller portions 18a and 18b of the right roller unit 18 are set at approximately the same positions in the axial direction. This configuration can suppress the deterioration of the straight traveling performance of the handheld printer 1 caused by differences in the positions of the roller portions between the roller units.

The pressing direction of the pressing flat spring 74 and the pressing flat spring for the right roller unit 18 is from the grip portion 36 (illustrated in FIG. 1) toward the opposite side in the axial direction. That is, the pressing flat springs 74 are attached at positions closer to the grip portion 36 than the roller units 17 and 18. Such placement can inhibit the deterioration of the straight traveling performance of the handheld printer 1 when the user moves the handheld printer 1 with an elbow placed on a desk.

Specifically, when the user grabbing the grip portion 36 places his or her elbow on the desk, the user is likely to move the handheld printer 1 in a curved track with the elbow serving as a fulcrum. At this time, when rattling of the roller units 17 and 18 is permitted, the shaft 17c or 18c of the roller unit 17 or 18 is brought into contact with the casing wall on the side opposite the grip portion 36 in the axial direction. Even in the structure in which the rattling of the roller unit is suppressed by the pressing force of a pressing flat spring, if the pressing force is in the direction toward the grip portion, it is possible that the roller unit moves to the side opposite the grip portion overcoming the applied pressure. Therefore, the pressing force is applied from the grip portion side to the opposite side. This structure can eliminate a margin for the roller unit to move to the side opposite the grip portion side and accordingly suppress the deterioration of the straight traveling performance of the handheld printer 1 when the user moves the handheld printer 1 with an elbow placed on a desk.

Instead of attaching the pressing flat spring to the casing, the pressing flat spring can be attached to the end portion of the shaft 17c (or 18c) of the roller unit 17 (or 18). Such a configuration can obviate a process of attaching the pressing flat spring to the casing, thereby reducing the cost for assembling.

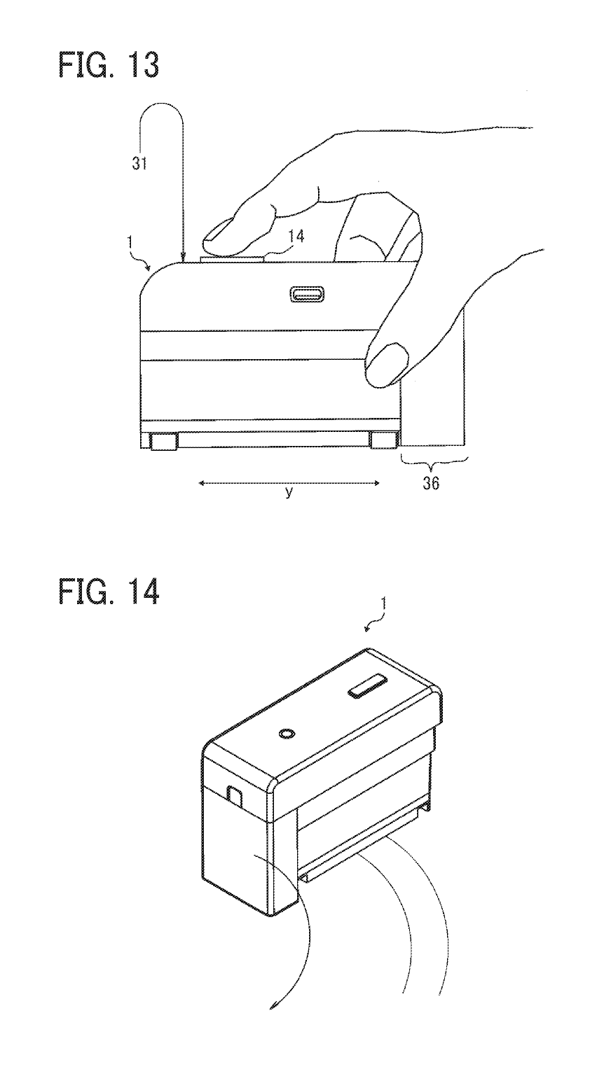

FIG. 13 is a side view illustrating a hand of the user moving the handheld printer 1. In the handheld printer 1, the grip portion 36 gripped by the user is positioned on one end side in the orthogonal direction y orthogonal to the scanning direction of the body of the handheld printer 1. Further, the print button 14, which is an instruction input portion operated for the operation of the recording section 41 (see FIG. 9), is disposed on the other end side (opposite the grip portion 36) of the upper side 31 in the orthogonal direction y to the scanning direction. That is, in the direction orthogonal to the scanning direction, the grip portion 36 and the print button 14 are on the opposite sides.

With such placement, before moving the handheld printer 1, the user can press the print button 14 with his or her index finger, holding the handheld printer 1 with his or her thumb hooked on the grip portion 36 of the handheld printer 1. In this state, the user can naturally float his or her wrist in the air. Such placement can prevent the following inconvenience. If the user moves the handheld printer 1 with the wrist rested on the desk, there is a risk that the direction of movement of the handheld printer 1 is deviated from a linear track by the movement of the hand centered on the wrist being a fulcrum about which the hand rotates.

As described above, since the handheld printer 1 includes the roller units 17 and 18 each configured to rotate the two roller portions (17a and 17b or 18a and 18b) as one unit, the straight traveling performance in the scanning direction of the handheld printer 1 can be improved. However, in some cases, the user desires to move the handheld printer 1 along a curved track. In this case, the roller units may obstruct the moving of the handheld printer 1 along the curved track.

Therefore, in the handheld printer 1, as illustrated in FIG. 9, the shafts 17c and 18c of the roller units 17 and 18 are respectively held by the sliding bearings 73 and 72 so that the shafts 17c and 18c are rotatable relative to and removable from the sliding bearings 73 and 72, respectively. As a result, the user can switch state of the handheld printer 1 in moving the handheld printer 1 to form an image on the recording medium P, as follows. That is, the user can switch the state of the handheld printer 1 between a roller contact state and a roller contactless state. In the roller contact state, the two roller portions (17a and 17b or 18a and 18b) in each of the roller units 17 and 18 are in contact with the recording medium P. In the roller contactless state, the roller portions do not contact the recording medium P. When the roller units 17 and 18 are removed from the sliding bearings 73 and 72, respectively, the handheld printer 1 becomes the roller contactless state.

On the recording side 30, three projections 71 are provided to support the body of the handheld printer 1 at three points. The projections 71 are made of plastic or the like. Respective tips of the projections 71 are positioned closer to the recording side 30 than the contact position between the roller portions 17a, 17b, 18a, and 18b and the recording medium P in the above-described roller contact state. Therefore, the projections 71 do not contact the recording medium P in the roller contact state. By contrast, in the roller contactless state, the projections 71 contact the recording medium P and float the recording side 30 of the handheld printer 1 in the air. Thus, the image can be protected from being disturbed by the recording side 30 rubbing against the image portion immediately after formed during image formation in the roller contactless state.

Each of the three projections 71 is disposed out of the range of the recording section 41 (the opening 30a of the recording side 30) in the orthogonal direction y to the scanning direction. More specifically, each of the three projections 71 is disposed such that the projection image of the projection 71 projected in the scanning direction (indicated by arrow x) does not overlap the projection image of the recording section 41 projected in the opposing direction of the recording section 41 and the recording medium P.

With such placement, the image can be protected from being disturbed by the projections 71 rubbing against the image portion immediately after formed during image formation in the roller contactless state.

FIG. 14 is a perspective view illustrating the handheld printer 1 being moved along a curved track in the roller contactless state. In the roller contactless state, since the handheld printer 1 is supported at three positions by the three projections 71, the curved traveling performance of the handheld printer 1 is improved, compared with the roller contact state. Therefore, the handheld printer 1 can be easily moved along the curved track.

Next, descriptions are given below of variations in which a portion of the above-described handheld printer 1 is changed. Other than the differences described below, the structure of the handheld printer 1 is similar to the structure in the above-described embodiment.

Variation 1

In the handheld printer 1 according to the above-described embodiment, the sliding bearings 73 and 72 are adopted for switching the state of the handheld printer 1 between the roller contact state and the roller contactless state. Alternatively, in Variation 1, a spacer is adopted.

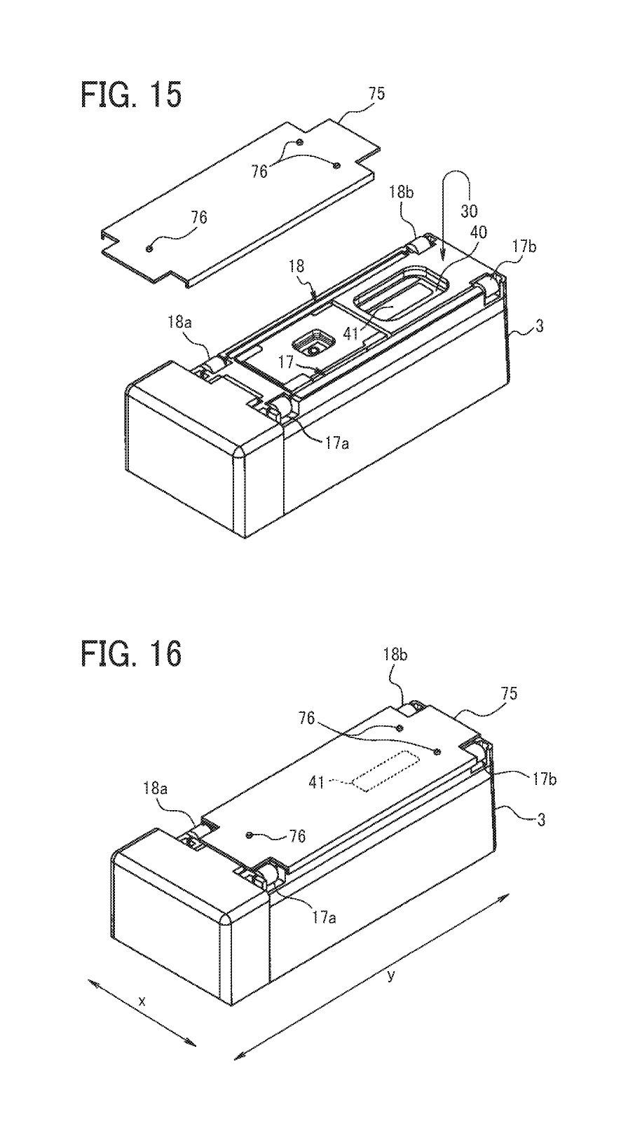

FIG. 15 is a perspective view illustrating the lower unit 3 of the handheld printer 1 and a spacer 75 as viewed from the recording side 30. The spacer 75 is attached to and removed from the recording side 30 of the lower unit 3 with a magnet.

FIG. 16 is a perspective view illustrating the lower unit 3 in a state in which the spacer 75 is mounted. Three projections 76 for supporting the handheld printer 1 at three positions project from the surface of the spacer 75. In the state where the spacer 75 is mounted on the recording side 30 (illustrated in FIG. 15) of the lower unit 3, the tips of the projections 76 are farther from the recording side 30 than the surface of the roller portion (17a, 17b, 18a, and 18b). Therefore, when the handheld printer 1 is placed on the recording medium P, the tips of the projections 76 are interposed between the recording side 30 and the recording medium P to float the roller portions 17a, 17b, 18a, and 18b from the surface of the recording medium P. As a result, a roller contactless state is realized.

Each of the three projections 76 is disposed out of the range of the recording section 41 in the orthogonal direction y to the scanning direction. More specifically, each of the three projections 76 is disposed such that the projection image of the projection 76 projected in the scanning direction (indicated by arrow x) does not overlap the projection image of the recording section 41 projected in the opposing direction of the recording section 41 and the recording medium P.

With such placement, the image can be protected from being disturbed by the projections 76 rubbing against the image portion immediately after formed during image formation in the roller contactless state.

In the above-described embodiment, the state of the handheld printer 1 is switched by attaching and removing the two roller units 17 and 18. Alternatively, in Variation 1, the state of the handheld printer 1 is switched by attaching and removing the spacer 75 only. Therefore, switching of the state can be easier compared with the above-described embodiment. By contrast, the above-described embodiment is advantageous in that, switching of the state is realized without increasing the number of parts (sliding bearings are necessary irrespective of switching of the state), thereby reducing the cost.

Variation 2

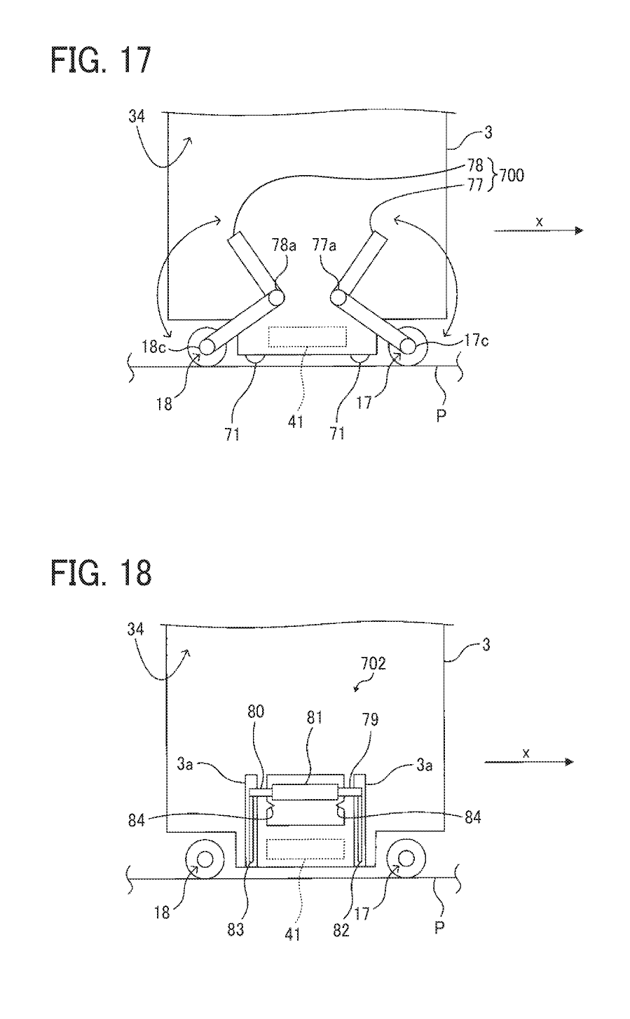

FIG. 17 is a partial rear view illustrating the lower unit 3 of the handheld printer 1 according to Variation 2. On the rear side 34 of the lower unit 3, a roller unit moving mechanism is provided. The roller unit moving mechanism to move the roller unit includes refracting arms 77 and 78, arm locking members, and the like. As the refracting arms 77 and 78 are rotated about rotation shafts 77a and 78a, respectively, the roller units 17 and 18 can be moved between a first position to contact the recording medium P and a second position contactless with the recording medium P. After the movement, the rotation of the refracting arms 77 and 78 is locked by the arm locking members, thereby also locking the movement of the roller units 17 and 18.

In FIG. 17, the lower unit 3 is in the roller contact state. When the refracting arms 77 and 78 (levers) are rotated to bring the roller portions 17a, 17b, 18a, and 18b of the roller units 17 and 18 closer to the upper side 31 (see FIG. 13), the roller units 17 and 18 can be separated from the recording medium P into the roller contactless state.

Such a configuration enables switching of the state of the handheld printer 1 while preventing the removable roller units 17 and 18 and the spacer 75 from being lost.

Variation 3

FIG. 18 is a partial rear view illustrating the lower unit 3 of the handheld printer 1 according to Variation 3. On the rear side 34 of the lower unit 3, a pin moving mechanism is provided. The pin moving mechanism includes pins 82 and 83 as supports, grooves 3a and 3b in the casing so as to accommodate the pins 82 and 83, arms 79 and 80 to which the pins 82 and 83 are fixed, a handle 81 for operating the arms 79 and 80, and the like.

As the handle 81 is moved up and down, the pins 82 and 83 move up and down between a first position closer to recording medium P than the roller units 17 and 18 and a second position farther from the recording medium P than the roller units 17 and 18. In FIG. 18, the lower unit 3 is in the roller contact state. Although it looks as if the roller 17 and 18 are separated from the lower unit 3 in the partial view of FIG. 18, the roller units 17 and 18 are rotatably supported by bearings provided to the lower unit 3. As the handle 81 is moved to the position of a hooking claw 84 and hooked on the hooking claw 84, the pins 82 and 83 become closer to the recording medium P than the roller units 17 and 18 and lift the handheld printer 1. As a result, the roller units 17 and 18 are separated from the recording medium P, and the handheld printer 1 is in the roller contactless state.

Such a configuration enables switching of the state of the handheld printer 1 while preventing the removable roller units 17 and 18 and the spacer 75 from being lost.

Variation 4

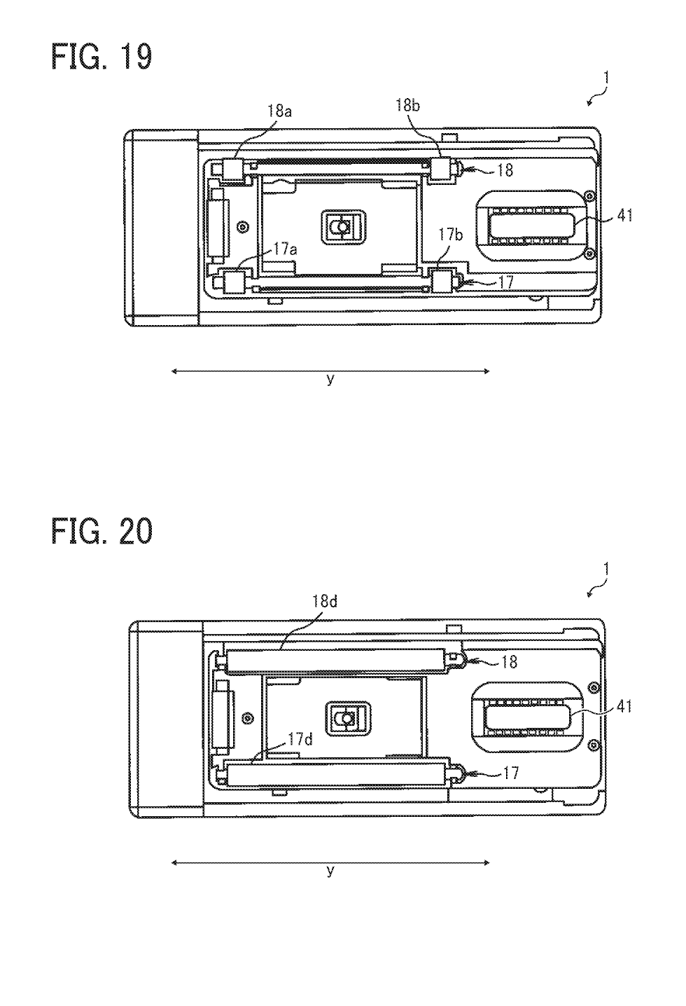

FIG. 19 is a bottom view illustrating the handheld printer 1 according to Variation 4. In the handheld printer 1 illustrated in FIG. 19, the two roller portions 17a and 17b of the left roller unit 17 are deviated toward the one end (e.g., left side in FIG. 19) from the recording section 41 in the orthogonal direction y to the scanning direction. Likewise, the two roller portions 18a and 18b of the right roller unit 18 are deviated from the recording section 41 to the same side on which the two roller portions 17a and 17b are disposed.

Such placement meets a layout constraint inhibiting the roller portion from being disposed at an end in the orthogonal direction y to the scanning direction.

Variation 5

FIG. 20 is a bottom view illustrating the handheld printer 1 according to Variation 5. The left roller unit 17 of the handheld printer 1 includes only a long roller portion 17d as a roller portion. The right roller unit 18 also includes only a long roller portion 18d as a roller portion. Both of the long roller portions 17d and 18d are deviated to one end side from the recording section 41 in the orthogonal direction y to the scanning direction.

There is a layout constraint requiring the roller portion to be deviated from the recording section 41 toward the one end side in the direction orthogonal to the scanning direction. Under such a constraint, depending on the layout of the apparatus, providing one long roller portion is advantageous over providing a plurality of roller portions. That is, in some cases, the total length of the roller portion(s) can be increased. As the total length of the roller portion(s) increases, the straight traveling performance of the handheld printer 1 can further improve.

Preferably, the recording section 41 is positioned as far as possible from the center of the handheld printer 1 in the direction orthogonal to the scanning direction. In the example illustrated in FIG. 20, the recording section 41 is disposed at the end in the orthogonal direction y to the scanning direction. Accordingly, the long roller portions 17d and 18d can be sufficiently long.

The length of each of the long roller portions 17d and 18d is preferably equal to or greater than 20 mm. Still more preferably, the length is equal to or greater than 40 mm. In the handheld printer 1, the length is equal to or greater than 40 mm.

Variation 6

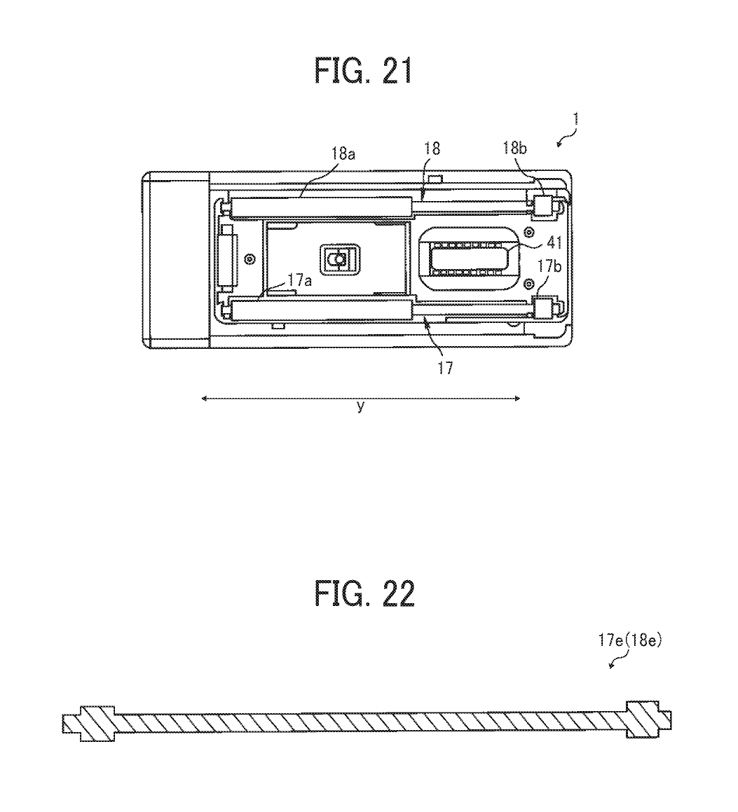

FIG. 21 is a bottom view illustrating the handheld printer 1 according to Variation 6. In the handheld printer 1, the first roller portions 17a and 18a of the roller units 17 and 18 are long roller portions. This structure further improves the straight traveling performance of the handheld printer 1.

In the above-described examples, the rubber roller portions (17a, 17b, 17d, 18a, 18b, and 18d) are attached to the metal shafts 17c and 18c. Alternatively, the shaft and the roller portion(s) can be molded as a single piece of the same material, as a roller member 17e (or 18e) illustrated in FIG. 22.

Although the example in which the present disclosure is applied to the inkjet handheld printer 1 has been described above, the aspects of the present disclosure can also be applied to other types of image forming apparatuses. The aspects of the present disclosure can be applied to a recording apparatus of, for example, thermal type or thermal-transfer type. A thermal-transfer type handheld mobile printer includes an ink ribbon as a container for storing liquid. Accordingly, a recess can be formed at the bottom of the ink ribbon, and a position sensor for detecting the recording medium can be disposed in a space formed by the recess.

The configurations described above are examples, and various aspects of the present disclosure can attain, for example, the following effects, respectively.

Aspect 1

Aspect 1 concerns a mobile image forming apparatus (for example, the handheld printer 1) that includes a body (for example, the casing of the lower unit 3) provided with two rotatable roller portions (for example, the first and second roller portions 17a and 17b or the first and second roller portions 18a and 18b). The mobile image forming apparatus forms an image on a recording medium (for example, the recording medium P) while the mobile image forming apparatus is moved in a scanning direction (for example, the direction indicated by arrow x) with the roller portions rotating on the surface of the recording medium. That is, the axis of the roller portions is orthogonal to the scanning direction.

The two roller portions are combined into a roller unit (for example, the left roller unit 17 and the right roller unit 18) to rotate coaxially.

In Aspect 1, the two roller portions that rotate on the recording medium are caused to rotated coaxially in a combined manner and inhibited from rotating separately. Even if the user applies a force in a direction deviating from the scanning direction to the mobile image forming apparatus, Aspect 1 can prevent a linear speed difference between the roller portions that causes one roller portion to slip on the surface of the recording material and prompts the direction change toward that direction. The two roller portions are rotated at the same linear speed to advance in the scanning direction. Accordingly, the mobile image forming apparatus can be easily moved straight in the scanning direction.

Aspect 2

In Aspect 2, the body of the mobile image forming apparatus according to Aspect 1 includes a recording side (for example, the recording side 30) on which a recording section (for example, the recording section 41) of the recording device (for example the inkjet head 40) mounted in the body is exposed toward the recording medium in order to record an image on the recording medium. Further, respective positions of the two roller portions are deviated from the recording section in an orthogonal direction (for example, the orthogonal direction y) along the recording side and orthogonal to the scanning direction.

In Aspect 2, since the roller portions are inhibited from contacting the image portion just formed on the recording medium by the recording device, image disturbance by the contact of the roller portion with the image portion just formed can be avoided.

Aspect 3

According to Aspect 3, in Aspect 2, one of the two roller portions is disposed at a first position deviated from the recording section toward one end side in the orthogonal direction to the scanning direction, and the other roller portion is disposed at a second position deviated from the recording section toward the other end side in the orthogonal direction.

In Aspect 4, since the roller portions are respectively disposed on one end side and the other end side of the mobile image forming apparatus body in the orthogonal direction to the scanning direction, the mobile image forming apparatus can stably move against the force pushing down one end side or the other end side of the mobile image forming apparatus body.

Aspect 4

According to Aspect 4, in Aspect 2, the respective positions of the two roller portions are deviated from the recording section toward one end side in the orthogonal direction to the scanning direction.

In Aspect 4, even if there is a layout constraint inhibiting the roller portions from being disposed on one end side of the mobile image forming apparatus in the orthogonal direction to the scanning direction, the two roller portions can be caused to rotate in a combined manner to enhance the straight traveling performance of the mobile image forming apparatus.

Aspect 5

According to Aspect 5, in Aspect 2, 3, or 4, the roller unit includes, at least, a metal shaft (for example, the shaft 17c or the shaft 18c) and the two roller portions (for example, the first and second roller portions 17a and 17b or the first and second roller portions 18a and 18b).

Compared with a structure using a nonmetallic shaft, Aspect 5 using of the metal shaft is advantageous in suppressing bend of the shaft during moving of the mobile image forming apparatus, thereby inhibiting the image from being disturbed by unstable traveling of the mobile image forming apparatus due to the bend of the shaft. Further, the mobile image forming apparatus can be compact when a shaft having a small diameter is used.

Aspect 6

According to Aspect 6, in Aspect 2, 3, 4, or 5, the roller unit includes, at least, the shaft and the two roller portions fixed to the shaft, and the mobile image forming apparatus further includes a pressing member (for example, the pressing flat spring 74) disposed in contact with the roller unit, to press the shaft in the axial direction of the roller unit.

In Aspect 6, the pressing member presses the shaft in the axial direction so as to prevent the roller unit from rattling in the axial direction. As the rattling in the axial direction of the two roller portions of the roller unit is suppress, disturbance of the image due to the rattling can be suppressed.

Aspect 7

According to Aspect 7, in Aspect 2, 3, 4, 5, or 6, a plurality of the roller units is arranged in the scanning direction. That is, the above-described roller unit (for example, the left roller unit 17) and at least one additional roller (for example, the right roller unit 18) are disposed side by side in the scanning direction.

In Aspect 7, the plurality of roller units resists, at different positions in the scanning direction, the above-described force deviating from the scanning direction. Accordingly, the straight traveling performance of the mobile image forming apparatus can be further enhanced.

Aspect 8

According to Aspect 8, in the Aspect 2, 3, 4, 5, 6, or 7, a grip portion (for example, the grip portion 36) to be gripped by a user is disposed on a first end side of the mobile image forming apparatus in the orthogonal direction to the scanning direction. Further, an instruction input portion (for example, the print button 14) operated for instructing an operation of the recording device is disposed on an upper side (for example, the upper side 31) of the mobile image forming apparatus body, and the instruction input portion is disposed on a second end side opposite the first end side in the orthogonal direction to the scanning direction.

If the user moves the mobile image forming apparatus with his or her wrist rested on a desk, the wrist may become a rotation fulcrum. Then, the direction of movement of the mobile image forming apparatus is deviated from a linear track by the movement of the hand centered on the rotation fulcrum. Aspect 8 can inhibit such deviation.

Aspect 9

According to Aspect 9, in Aspect 2, 3, 4, 5, 6, 7, or 8, the mobile image forming apparatus further includes a switching device (for example, the sliding bearings 72 and 73 or the spacer 75) to switch a state of the mobile image forming apparatus body placed on the surface of the recording medium with the recording side facing opposite the recording medium. The switching device switches the state of the mobile image forming apparatus body between a roller contact state in which the two roller portions contact the surface of the recording medium and a roller contactless state in which the two roller portions are contactless with the surface of the recording medium.

According to Aspect 9, when the user desires to move the mobile image forming apparatus along a linear track, the linear traveling performance of the mobile image forming apparatus is enhanced. Simultaneously, when the user desires to move the mobile image forming apparatus along a curved track, the curved traveling performance of the mobile image forming apparatus can be enhanced.

Aspect 10

According to Aspect 10, the switching device stated in Aspect 9 includes a holder (for example, the sliding bearings 72 and 73) to hold the roller unit rotatably and removably.

According to Aspect 10, the switching between the roller contact state and the roller contactless state can be attained without increasing the number of parts.

Aspect 11

According to Aspect 11, in Aspect 10, the recording side of the mobile image forming apparatus body includes a plurality of projections (for example, the projections 71) to support, at a plurality of positions, the body from which the roller unit is removed.

According to Aspect 11, since the mobile image forming apparatus body being in the roller contactless state is supported at a plurality of positions (i.e., supported at points not in a large face), the curved traveling performance of the mobile image forming apparatus can be enhanced compared with a configuration in which a face of the body is supported.

Aspect 12

According to Aspect 12, the switching device stated in Aspect 9 includes a removable spacer (for example, the spacer 75) to be interposed between the mobile image forming apparatus body and the surface of the recording medium in a state in which the switching device is attached to the body. The spacer is configured to float the two roller portions from the recording medium.

According to Aspect 12, switching between the roller contact state and the roller contactless state can be easier compared with Aspect 10.

Aspect 13

According to Aspect 13, in the Aspect 12, a plurality of projections (for example, the projections 76) projects from a surface of the spacer, and the plurality of projections supports the mobile image forming apparatus body at a plurality of positions.

According to Aspect 13, since the body of the mobile image forming apparatus being in the roller contactless state is supported at a plurality of positions, the curved traveling performance of the mobile image forming apparatus can be enhanced compared with a configuration in which a face of the body is supported.

Aspect 14

In Aspect 14, in Aspect 11 or 13, the respective positions of the plurality of projections are deviated from the recording section in the orthogonal direction to the scanning direction.

In Aspect 14, since the projections are inhibited from contacting the image portion just formed on the recording medium by the recording section, disturbance of the image by the contact of the projections with the image portion just formed can be avoided.

Aspect 15

Aspect 15 concerns a mobile image forming apparatus that includes a recording device (for example, the inkjet head 40) to form an image on a recording medium and a rotatable roller portion (for example, the long roller portion 17d or 18d) provided to a mobile image forming apparatus body. The mobile image forming apparatus forms an image on a recording medium while the body is moved in a scanning direction with the roller portion rotating on the surface of the recording medium. The body includes a recording side (for example, the recording side 30) on which a recording section (for example, the recording section 41) of the recording device is exposed toward the recording medium. The position of the roller portion is deviated from the recording section in a direction along the recording side and orthogonal to the scanning direction.

Aspect 15 is advantageous under a constraint requiring the roller portion be disposed in an area deviated toward one end side from the recording section in the orthogonal direction to the scanning direction. In a layout in which providing one long roller portion can increase the total length of the roller portion(s) than providing a plurality of roller portions, the total length of the roller portion(s) can be increased, thereby better improving the straight traveling performance.

Aspect 16

According to Aspect 16, in Aspect 15, the length of the roller portion is equal to or longer than 20 mm.

Aspect 17

According to Aspect 17, in Aspect 15 or 16, the position of the recording section is deviated from a center of the mobile image forming apparatus body in the orthogonal direction to the scanning direction.

According to Aspect 17, disposing the recording section at a position deviated from the center of the mobile image forming apparatus in the orthogonal direction to the scanning direction is advantageous in increasing the length of the roller portion.

Aspect 18

Aspect 18 concerns a body (e.g., the casing of the lower unit 3) of a mobile image forming apparatus including a recording device (e.g., the inkjet head 40) removably mounted in the body. The body is provided with two rotatable roller portions (e.g., the first and second roller portions 17a and 17b or the first and second roller portions 18a and 18b). The mobile image forming apparatus forms, with the recording device, an image on a recording medium (e.g., the recording medium P) while the body is moved in a scanning direction with the two roller portions rotating on the surface of the recording medium. The two roller portions are combined into a roller unit (for example, the left roller unit 17 and the right roller unit 18), to rotate coaxially.

Aspect 19

Aspect 19 concerns a body (e.g., the lower unit 3) of a mobile image forming apparatus including a recording device (e.g., the inkjet head 40) to be removably mounted in the body. The body is provided with a rotatable roller portion (e.g., the roller portion 17d or 18d). The mobile image forming apparatus forms, with the recording device, an image on a recording medium while the body is moved in a scanning direction with the roller portion rotating on the surface of the recording medium. The body includes a recording side (for example, the recording side 30) on which a recording section (for example, the recording section 41) of the recording device is exposed toward the recording medium. The position of the roller portion is deviated from the recording section in a direction along the recording side and orthogonal to the scanning direction.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

What is claimed is:

1. An image forming apparatus comprising:
a body;
a recording device supported by the body, the recording device including a recording section configured to form an image on a recording medium; and
two roller portions provided to the body and configured to rotate on the recording medium while the body is moved in a scanning direction for image formation, the two roller portions combined into a roller unit to rotate coaxially.

2. The image forming apparatus according to claim 1,
wherein the body includes a recording side on which the recording section is exposed, and
wherein respective positions of the two roller portions are deviated from the recording section in an orthogonal direction along the recording side and orthogonal to the scanning direction.

3. The image forming apparatus according to claim 2,
wherein one of the two roller portions is disposed at a first position deviated from the recording section toward one end side of the body in the orthogonal direction, and
wherein the other of the two roller portions is disposed at a second position deviated from the recording section toward the other end side of the body in the orthogonal direction.

4. The image forming apparatus according to claim 2,
wherein the respective positions of the two roller portions are deviated from the recording section toward one end side of the body in the orthogonal direction to the scanning direction.

5. The image forming apparatus according to claim 2,
wherein the roller unit further includes a metal shaft to which the two roller portions are fixed.

6. The image forming apparatus according to claim 2,
wherein the roller unit further includes a shaft to which the two roller portions are fixed, and
wherein the image forming apparatus further comprises a pressing member disposed in contact with the roller unit and configured to press the shaft in an axial direction of the roller unit.

7. The image forming apparatus according to claim 2, further comprising at least one additional roller unit, and
wherein the roller unit and the at least one additional roller unit are arranged in the scanning direction.

8. The image forming apparatus according to claim 2,
wherein the body includes:
a grip portion to be gripped by a user and disposed on one end side of the body in the orthogonal direction; and
an instruction input portion disposed on the other end side of the body in the orthogonal direction and on an upper side of the body, the instruction input portion to be operated by the user for input of an operation instruction.

9. The image forming apparatus according to claim 2, further comprising a switching device configured to switch a state of the image forming apparatus during image formation between:
a roller contact state in which the two roller portions are in contact with the recording medium; and
a roller contactless state in which the two roller portions are contactless with the recording medium.

10. The image forming apparatus according to claim 9, wherein the switching device includes a holder configured to hold the roller unit rotatably and removably from the holder, and
wherein the state of the image forming apparatus is switched by the roller unit being attached to and removed from the holder.

11. The image forming apparatus according to claim 10, further comprising a plurality of projections projecting from the recording side of the body,
wherein the plurality of projections supports the body without the roller unit.

12. The image forming apparatus according to claim 11,
wherein each of the plurality of projections is disposed at a position deviated from the recording section in the orthogonal direction.

13. The image forming apparatus according to claim 9,
wherein the switching device includes a spacer to be removably attached to the recording side of the body and interposed between the body and the recording medium, to float the roller unit from the recording medium, and
wherein the state of the image forming apparatus during image formation is switched by the spacer being attached to and removed from the body.

14. The image forming apparatus according to claim 13, wherein a surface of the spacer includes a plurality of projections to support the body.

15. An image forming apparatus comprising:
a body including a recording side;
a recording device supported by the body, the recording device including a recording section configured to form an image on a recording medium and exposed on the recording side; and
a roller portion provided to the body and configured to rotate on the recording medium while the body is moved in a scanning direction for image formation, the roller portion disposed at a position deviated from the recording section in an orthogonal direction along the recording side and orthogonal to the scanning direction.

16. The image forming apparatus according claim 15,
wherein the roller portion has a length not shorter than 20 mm.

17. The image forming apparatus according to claim 15,
wherein a position of the recording section is deviated from a center of the body in the orthogonal direction.

18. A body of an image forming apparatus to form an image on a recording medium, the body configured to house a recording device to form an image on a recording medium, the body comprising:
two roller portions configured to rotate on the recording medium while the body is moved in a scanning direction for image formation, the two roller portions combined in a roller unit to rotate coaxially.
